(19) United States
(12) Patent Application Publication
(10) Pub. No.: US 2017/0310936 A1
(43) Pub. Date: Oct. 26, 2017

(54) SITUATION AWARENESS SYSTEM AND METHOD FOR SITUATION AWARENESS IN A COMBAT VEHICLE

(71) Applicant: BAE Systems Hägglunds Aktiebolag, Örnsköldsvik (SE)

(72) Inventor: Daniel NORDIN, Örnsköldsvik (SE)

(73) Assignee: BAE Systems Hägglunds Aktiebolag, Örnsköldsvik (SE)

(21) Appl. No.: 15/512,533

(22) PCT Filed: Nov. 9, 2015
(86) PCT No.: PCT/SE2015/051180

§ 371 Date: Mar. 17, 2017

(30) Foreign Application Priority Data
Nov. 7, 2014 (SE) 1451335-2

(51) Int. Cl. H04N 7/18; H04N 5/268; H04N 5/265; H04N 5/77; G06T 3/40

(52) U.S. Cl. CPC H04N 7/181; H04N 5/77; G06T 3/4038; H04N 5/265; H04N 5/268

(57) ABSTRACT

The invention relates to a system (1) for situation awareness in a combat vehicle (2), comprising a plurality of image-capturing sensors (3A-3E) configured to record image sequences showing different partial views (V_{A}-V_{E}) of the surroundings of the combat vehicle, and a plurality of client devices (C1-C3) wherein each is configured to show a view (V_{P}) of the surroundings of the combat vehicle, desired by a user of the client device, on a display (D1-D3). The image-capturing sensors are configured to be connected to a network (4) and to send said image sequences over said network by means of a technique in which each image sequence sent by an image-capturing sensor can be received by a plurality of receivers, such as multicast. The client devices are also configured to be connected to said network and to receive, via said network, at least one image sequence recorded by at least one image-capturing sensor (3A-3E). Further, each client device is configured to generate, on its own, said desired view from the at least one image sequence by processing images from the at least one image sequence, and to provide for display of the desired view on said display.

### TECHNICAL FIELD

The present invention relates to a situation awareness system and a method for situation awareness in a combat vehicle. In particular, the invention relates to a situation awareness system and method for enabling operators of combat vehicles, such as drivers, shooters, vehicle commanders, and any other crew, such as vehicle mounted troop, to perceive, via displays inside the combat vehicle, the situation outside the combat vehicle. The invention also relates to a combat vehicle comprising such a situation awareness system and a computer program for situation awareness in a combat vehicle.

### BACKGROUND ART

Modern combat vehicles are typically equipped with a set of sensors, such as radar sensors, acoustic sensors, periscope and/or electro-optical sensors, such as cameras, infrared cameras and image intensifiers for sensing the environment (objects/threats/terrain) in the surroundings of the combat vehicle. The information collected by means of the sensor set is normally used to provide situation awareness for operators and other personnel in the combat vehicle. Sometimes the sensor information is supplemented with tactical information, which typically is provided by a combat management system of the vehicle, including for example digitized maps having stored and/or updated tactical information, and sometimes even with technical information, for example on the speed/position of the vehicle, remaining fuel quantity and ammunition etc., obtained by other sensors of the vehicle.

An often essential component in a situation awareness system of the type specified above is an observation system for providing visual information regarding the surroundings of the combat vehicle to vehicle operators and possible personnel located inside the combat vehicle. Such an observation system typically comprises a number of optoelectronic sensors, such as cameras or video cameras, each configured to display a part of the surroundings of the combat vehicle. In early types of observation systems, each camera was typically connected to a separate display, which required a plurality of displays to convey a complete 360-degree view of the surroundings of the combat vehicle. In other types of early observation systems the views from the different cameras could be shown together on a single display.

In more modern observation systems, such as those disclosed in US2012/0229596, US2013073775 and WO2004036894, images from a plurality video cameras, each adapted to display the surroundings in a certain direction in relation to the vehicle, are combined into a panoramic view, whereupon the whole or part of this panoramic view can be shown on different displays belonging to different members of the vehicle crew. Often, a powerful computer generates a complete 360-degree panoramic view or a complete sphere having the solid angle 4π steradians based on a plurality of video streams received from the different video cameras, whereupon selected parts of this panoramic view are shown to the different crew members on different displays connected to said computer.

A problem with these panoramic generating observation systems is that it takes a lot of computing power to create, based on the different video streams, a complete 360-degree panoramic view or sphere. This puts high demands on the graphics card and other components performing the calculations required to properly stitch together the video streams from the different cameras, particularly at high resolution video having 30 video images per second or more.

Another problem is that the large amount of data created from all of the video cameras puts high demands on the computer that receives all video streams. Known solutions to manage the large amount of input data consist of, for example, equipping the computer with hardware that sorts out the video cameras needed to create the field(s) of view requested by crew members, so that the computer only has to handle these video streams. In practice, this solution causes a limit of how many displays and crew members that the computer can support. The sorting hardware also causes an increased cost as such hardware normally is not found in a general-purpose computer.

Thus, there is a need for an improved situation awareness system and an improved method for situation awareness in combat vehicle(s).

### OBJECT OF THE INVENTION

An object of the present invention is to provide a solution for situation awareness in vehicles, which solves or at least alleviates one or more of the above problems with situation awareness systems according to prior art.

A particular object of the present invention is to provide a situation awareness system for combat vehicles, which can be made cheaper and more robust than prior art situation awareness systems.

### SUMMARY OF THE INVENTION

These and other objects, which will be apparent from the following disclosure, are achieved by a system for situation awareness in a combat vehicle, which system has the features stated in appended independent claim 1. Furthermore, said objects are achieved by a combat vehicle according to claim 12, a method for situation awareness in a combat vehicle according to claim 13, a computer program for situation awareness in a combat vehicle according to claim 20 and a computer program product according to claim 21. Preferred embodiments of the system and the method are specified in the dependent claims 2-11 and 14-19.

In one aspect, the objects are achieved by means of a system for situation awareness in a combat vehicle, wherein the system comprises a plurality, i.e. at least two, image-capturing sensors configured to record image sequences showing parts, or partial views, of the surroundings of the combat vehicle. Further, the system comprises a plurality of client devices, each configured to show a view of the surroundings of the combat vehicle, desired by a user of the client device, on a display. The image-capturing sensors are configured to be connected to a network, typically Ethernet, and to send said image sequences over said network by means of a technique in which an image sequence that is sent once and only once from an image-capturing sensor can be received by a plurality of receivers, for example by means of multicasting. The client devices are also configured to be connected to said network, wherein the network can be said to constitute a local area network of the combat vehicle to which all image-capturing sensors and all client devices are connected. The client devices are configured to receive, via said network, at least one image sequence recorded by at least one image-capturing sensor, and to generate, on its own, the desired view of the surroundings of the combat vehicle by processing images from said at least one image sequence, and to provide for display of the desired view on said display.

The client is further configured to demand, receive and, on its own, stitch images from a plurality of image-capturing sensors, if the view desired by the user requires images from more than one image-capturing sensor.

Unlike most known systems for situation awareness in combat vehicles, which generally consist of a powerful special purpose computer that receives the image sequences from all of the image-capturing sensors of the system, stitches the different image sequences to an often complete, 360-degree panoramic view, and shows the desired parts of this panoramic view on different displays connected to said computer, the system of the present invention consists of a distributed system where a plurality of separate client devices are all connected to the image-capturing sensors via a network of the combat vehicle. In this way, each client device can demand, based on an indication of the desired view from the user of the client device, image sequences solely from the image-capturing sensor(s) needed to create the desired view, wherein the maximum number of images that need to be merged by the system can be greatly reduced. By using multi-receiver technique, such as IP multicast, it is guaranteed that each of the plurality of client devices can demand and obtain the image sequences required for showing the desired view, regardless of which image sequences that are demanded by other client devices. Thus, by enabling a plurality of client devices to demand the image sequences needed to create a desired view directly from the image-capturing sensors being connected to the network, and by providing each client device with functionality to generate said desired view based on the demanded image sequence(s), the need is eliminated for a powerful and specially adapted computer capable of receiving and merging the image sequences from a large number of image-capturing sensors and presenting the whole or parts of the merged panoramic view on displays connected thereto. Furthermore, the complexity and the component cost of the system is reduced without such a capacity-intensive computer or central processing device, at the same time as the system becomes more robust and scalable and less vulnerable.

The proposed system is designed so that processing of image sequences from the image-capturing sensors is performed by and only by the client devices, which means that the system does not involve any further data processing device, independent from the client devices, that is responsible for merging or otherwise processing the image sequences for later transmission to the respective client device. Further, the system does not comprise any special-purpose hardware components in form of particularly sophisticated and costly video processing cards for processing the image sequences from the different image-capturing sensors, or multiplexers (mux) for sharing image sequences. Instead, the combination of network-connected image-capturing sensors with multi-receiver functionality and network-connected client devices capable of retrieving and processing the particular image sequences required for the desired view directly from the image-capturing sensors, enables the system to be constituted by standard components. For example, in one embodiment, the client devices are constituted by general-purpose computers without special video processing cards, special plug-in cards, or other special-purpose hardware with the specific purpose of processing data-intensive image sequences.

In general, the system in a preferred embodiment comprises no additional hardware or software components that modify the image sequences along the way between the image-capturing sensors and the client devices. As described below, the system can in some embodiments comprise a network switch, in addition to image-capturing sensors and client devices, but then this network switch has the sole task of controlling and duplicating data in the network, which does not involve modification of the image sequences.

In one embodiment, at least one client device is configured to receive a plurality of image sequences recorded by different image-capturing sensors, merge images from the received image sequences into a merged image comprising image information recorded by different image-capturing sensors, and show, on said display, the merged image or part thereof as said desired view. Thus, in this embodiment, the above mentioned processing of images from at least one image sequence received by the client device comprises merging images from a plurality, i.e. at least two, images sequences recorded by different image-capturing sensors.

Thus, in one embodiment, at least one and preferably all of the client devices in the system is configured to demand from the image-capturing sensors only the image sequences needed to create the view desired by the user of the client device. The system is designed so that the user can indicate, by means of the client device, a desired view requiring image information from more than image-capturing sensor, wherein the client device, if the user indicates such a desired view, is configured to demand, receive and, on its own, merge images from a plurality of image-capturing sensors, and to provide for display of the desired view in form of said merged image or a portion thereof.

In a preferred embodiment, at least one client device is configured to, if necessary, generate a panoramic view from a plurality of received image sequences recorded by different image-capturing sensors and present the generated panoramic view as said desired view. The above described merging of images can, if necessary, be carried out in such a way that the merged image constitutes a panoramic image, i.e. a contiguous image that spans across a field of view larger than the field of view of a single image-capturing sensor. With a slightly different wording, in such a case, the merged image shows a panoramic view which covers a larger field of view than the partial views recorded by the respective image-capturing sensor.

For such a panoramic generation, the client devices can be configured to create the desired views that are displayed on the displays associated with the client devices by merging an essentially arbitrary number of images from different image sequences recorded by different image-capturing sensors. However, since the object of the present invention is to eliminate calculation-intensive processes, and thus the need for expensive and complex high-capacity components, each client device is preferably configured to, when panoramic generation is needed, create the desired view by merging preferably only two and at most three images from image sequences recorded by different image-capturing sensors. Usually it is sufficient to merge image sequences from two image-capturing sensors to create a panoramic view desired by a vehicle operator. This means that each client device during panoramic generation usually do not need to stitch images from different image sequences with more than one seam, even if client devices capable of merging substantially more images from different image sequences also fall well within the scope of the invention. Since each client device usually only needs to image stitch two images at a time, the client devices do not need to possess any greater computing capacity, despite the ability of the system to show a large number of panoramic images for a large number of users.

Further, in this manner the system never needs to create a complete 360-degree panoramic view or sphere of the surroundings of the combat vehicle, which often have to be made in panoramic generating situation awareness systems according to prior art. In the proposed system, each client device itself creates the view currently desired by the user of the client device based on the minimum number of image sequences needed to create the desired view, which in addition to minimizing the requirements on calculation capabilities of the client devices also minimizes the requirements on data transfer capacity in the network. It also means that no component in the system needs to receive and manage all of the image sequences recorded from the different image-capturing sensors, a process which, just like the merging of all image sequences, is very capacity-intensive.

The fact that the system advantageously is capable of generating and presenting, by means of the client devices, panoramic views of the surroundings of the combat vehicle to the members of the vehicle crew, does not mean that this have to be the case. Instead, at least one of the client devices may be configured to generate the desired view from an image sequence received from one single image-capturing sensor. In this case, the client device does not have to be configured for merging images to generate a panoramic view but should nevertheless be configured for other types of processing of the images in the single received image sequence before these are displayed as the desired view on the display of the client device. Such processing may for example comprise: extracting selected image parts, wherein the client device may be configured to cut out parts of the images in the received sequence for generating the desired view; projecting the images or said parts on a curved surface, wherein the client device may be configured to create a spherical or cylindrical projection of the images in the received sequence for generating the desired view; and/or scaling the images or said parts, wherein the client device may be configured to rescale the images in the received sequence for generating the desired view.

However, the client devices are preferably provided with functionality to merge images from a plurality of image sequences and configured to merge images from different image sequences to a panoramic view, if necessary to show the desired view as indicated by the user of the client device.

Preferably, the client devices are configured to generate the desired view from a minimum of image sequences, which may comprise image sequences from one, several or all image-receiving sensors, but typically comprise image sequences from one or two image-capturing sensors. For example, the client device may be configured to generate the desired view from only one image sequence, without performing any merging of images, as long as the desired view as indicated by the user falls entirely within the field of view or a central part of the field of view of a single image-capturing sensor, and generate the desired view by merging images from two or more image-capturing sensors if the desired view falls outside said field of view or central part of the field of view.

In one embodiment, the image-capturing sensors and the client devices are connected via one or more network switches of the system, such as an Ethernet switch, configured to receive requests, from the client devices, for image sequences to be sent from selected image-capturing sensors and, based on said requests, selectively communicate image sequences from the different image-capturing sensors to the different client devices.

Each client device is further configured to receive an indication of a desired view from a user of the client device, typically an operator or other crew member of the combat vehicle, and, based on said indication of desired view, determine which image-capturing sensors the recorded image sequences of which have to be merged in order to generate the desired view. The client device is further configured to send a request (within the multicast technique, sometimes called the “join request”) to said network switch for image sequences to be sent from these image-capturing sensors, wherein the network switch after receipt of said request ensures that the current client device receives the requested image sequences.

Advantageously, each image-capturing sensor is configured to send each recorded image sequence one and only one time, wherein the network switch is configured to receive said image sequence and, at least if said image sequence has been requested by a plurality of client devices, duplicate the image sequence and send the received image sequence or a copy thereof to each of the client devices from which a request for the current image sequence to be sent has been received.

Thus, in an embodiment this functionality is obtained by a switch in the system in the form of an Ethernet switch supporting multicast, which cooperates with the image-capturing sensors provided with a network interface supporting multicast to provide the required distribution of image sequences from the image-capturing sensors to the client devices with a minimum of data traffic in the network.

The client devices can generally be constituted by any type of data processing device capable of processing, in a desired manner, images from the received image sequence(s) from which they generate the desired view. For the above mentioned panoramic generation for example, the client devices have to be able to merge images from different image sequences into a panoramic image and cause display of said panoramic image on a display of the client device or connected to the client device. For example, the client devices may be constituted by stationary computing devices, portable computing devices, tablet computers or helmet integrated computing devices.

In one embodiment, at least one client device or a component connected thereto comprises a direction sensor, such as a gyroscope or an accelerometer, wherein the client device is configured to sense how the client device or the component connected thereto is directed, and, based on said direction, determine which view of the surroundings of the combat vehicle that constitutes the desired view and thus which view should be displayed on the display of the client device.

In the above described embodiment according to which the client devices send requests for desired image sequences to be sent to a network switch through which the client devices are connected to the image-capturing sensors, said requests are advantageously based on the current direction of the client device or the component connected thereto, wherein the view displayed on the display of the client device will depend on said direction.

For example, the client device may be integrated in or connected to a helmet comprising a helmet display and a direction sensor capable of sensing how a user of the helmet directs his head, wherein the client device is configured to, based on said head direction, determine which view that constitutes desired view and thus should be displayed on said helmet display. In this way, an operator or other crew member of the combat vehicle is given a very realistic feeling of seeing right through the walls of the combat vehicle and/or ceiling while being protected inside the combat vehicle.

In another example, the client device is constituted by a tablet computer, such as a tablet device, with built-in direction sensor, wherein a user can turn the tablet computer in the direction in which the user desires to “see” through the combat vehicle.

As understood from the above description, the desired view shown on the display of the client device may be generated from one single image sequence recorded by a single image-receiving sensor, or from a plurality of image sequences recorded by different image-capturing sensors, wherein the images from different image sequences on one or the other way may be merged to a merged image constituting said desired view.

It should be emphasized in this context that a merged image is not necessarily a panoramic image. The image-capturing sensors can for example comprise both conventional video cameras and infrared cameras, wherein the desired view may be constituted by a merged image merged from an image recorded by a video camera and an image recorded by an infrared camera, for example a merged image in which the image information from the infrared camera has been superimposed on image information from the video camera. Thus, it should also be appreciated that the partial views recorded by the different image-capturing sensors not necessarily need to be different parts or different partial views of the surroundings of the combat vehicle. They may for example be constituted by a visual view and an infrared view of the same part of the surroundings of the combat vehicle, recorded by a conventional video camera and an infrared camera, which views can be merged by the different client devices in order to provide, in a desired view, operators of the vehicle possibility to see the image information from the infrared camera superimposed on image information from the conventional video camera.

Mainly, however, the proposed system is supposed to be used to display panoramic views in form of images and especially video images to the vehicle operators on the different client devices, which are therefore primarily intended to merge images from image-capturing sensors in form of conventional cameras or video cameras to panoramic images for display on the displays of the client devices.

In one embodiment, at least one of the client devices comprises panning means configured to provide panning in a panoramic view displayed by the client device based on input data inputted or otherwise generated by the user of the client device.

In one embodiment, at least one of the client devices is configured to display on its display a spherical panoramic view or parts thereof provided by application of a spherical projection on the merged images from the different image sequences. In this way, an almost totally realistic feeling of being surrounded by the surroundings of the combat vehicle is communicated to vehicle operators or other members of the vehicle crew located inside the combat vehicle. A complete spherical panorama requires merging of a large number of images, which require increased performance of the client devices both in terms of the ability to merge images and the ability to receive and manage the large amount of data in the many different image sequences to be merged. The client devices can therefore advantageously be configured to generate and display only a part of a complete spherical panoramic view, for example a partial view consisting of two or three merged image sequences.

In another embodiment, said at least one client device is configured to display on its display a cylindrical panoramic view or parts thereof provided by application of a cylindrical projection on the merged images from the different image sequences. Thus, an almost totally realistic feeling of being surrounded by the surroundings of the combat vehicle is communicated to the crew members of the vehicle with lower performance requirements on the client devices in the system. Also in this case the client devices are advantageously configured to generate and display only a portion of a complete cylindrical panoramic view, for example a partial view consisting of two or three merged image sequences.

According to another aspect of the invention there is provided a combat vehicle comprising the above described system for situation awareness.

In one embodiment, the combat vehicle thus comprises a plurality of image-capturing sensors, such as video cameras, each configured to record an image sequence showing a partial view of the surroundings of the vehicle, and a plurality of client devices each being configured to display, on a display, a desired view of the surroundings of the combat vehicle, wherein the desired view comprises image information created by merging images recorded by different image-capturing sensors. The image-capturing sensors and the client devices are connected to each other through a network of the combat vehicle and the image-capturing sensors are configured to send said image sequences over said network by means of a technique where each image sequence can be received by a plurality of receivers.

Further, each of the client devices are configured to receive, via said network, a plurality of image sequences recorded by different image-capturing sensors and generate, on its own, the desired view from the received image sequences, typically in the form of a panoramic view, by merging images from different image sequences, and provide for display of the desired view on said display.

Besides the above-described system and combat vehicle, the present invention also provides a method for situation awareness in combat vehicle(s).

In one embodiment, a method is provided for situation awareness in combat vehicle(s), comprising the steps of recording a plurality of image sequences showing partial views of the surroundings of the combat vehicle by means of a plurality of image-capturing sensors, and displaying, on each of a plurality of displays associated with a respective client device of a plurality of client devices, a view of the surroundings of the combat vehicle, desired by a user of the client device. Further, the method comprises the steps of:
sending the image sequences from the image-capturing sensors over a network of the combat vehicle by means of a technique in which each image sequence can be received by a plurality of receivers,
   and, in each of said plurality of client devices:
receiving, over said network, at least one image sequence recorded by at least one image-capturing sensor;
generating, from said at least one image sequence, said desired view by processing images in said at least one image sequence, and
displaying the desired view on the display associated with the client device.

As apparent from the above description, the step of generating the desired view typically comprises generating a panoramic view, wherein the step of displaying the desired view comprises display of the panoramic view or parts thereof on the display.

As also apparent from the above description, the method may comprise the steps of:
registering a direction of the respective client device or a component connected to the respective client device, and
sending, from the respective client device, said request for selected image sequences to be sent in order to generate said desired view, based on said direction.

According to yet another aspect of the present disclosure there is provided a computer program for providing situation awareness in a combat vehicle comprising a plurality of image-capturing sensors configured to record image sequences showing respective partial views of the surroundings of the combat vehicle. The computer program comprises program code which when executed by a processor in one of a plurality of client devices causes the client device to display, on a display, a view of the surroundings of the combat vehicle, desired by a user of the client device. Further, the computer program comprises program code which when executed by said processor causes the client device to, via a network of the combat vehicle over which said image-capturing sensors send the image sequences by means of a technique in which each image sequence can be received by a plurality of receivers:
receive at least one image sequence recorded by at least one image-capturing sensor;
generate, based on said at least one image sequence, said desired view by processing images from said at least one image sequence, and
display the desired view on a display associated with the client device.

The computer program may further comprise program code which when executed by said processor causes the client device to perform any one or any of the method steps described above as being performed by a client device.

According to a further aspect of the present disclosure there is provided a computer program product comprising a storage medium, such as a non-volatile memory, wherein said storage medium stores the above described computer program.

According to a further aspect of the present disclosure there is provided a client device, such as a desktop computer, a laptop, a tablet computer, a helmet integrated computer, or any other type of data processing device, comprising such a computer program product.

Further advantageous aspects of the system, the combat vehicle, the method and the computer program of the invention will become apparent from the following detailed description and the subsequent claims.

### DESCRIPTION OF FIGURES

The present invention will be better understood by reference to the following detailed description when considered together with the accompanying drawings, in which the same reference numerals refer to the same parts in the different views, and in which:

FIG. 1 schematically illustrates one embodiment of a system for providing situation awareness in a combat vehicle;

FIG. 2 schematically illustrates an example of a panoramic view which, by the system of FIG. 1, can be generated and shown, entirely or partly, for providing situation awareness to one or more members of the vehicle crew;

FIG. 3 schematically illustrates another example of a panoramic view which, by the system of FIG. 1, can be generated and displayed, entirely or partly, for providing situation awareness to one or more members of the vehicle crew; and

FIG. 4 schematically illustrates an example of data communication between the devices in a network to which the system components in FIG. 1 are connected.

FIG. 5 schematically illustrates a flow diagram of one embodiment of a method for providing situation awareness in a combat vehicle.

### DETAILED DESCRIPTION OF THE INVENTION

By “merging images” is meant a process in which a new image is generated by merging together two or more original images, wherein the new image comprises image information from each of the merged original images.

With “panoramic view” is meant a wide angle view that comprises more image information than can be recorded by a single image capturing sensor. Thus, a panoramic image is a wide angle image created by merging a plurality of images recorded by different image-capturing sensors, merged in such a way that the panoramic image shows a larger field of view than the individual images do individually.

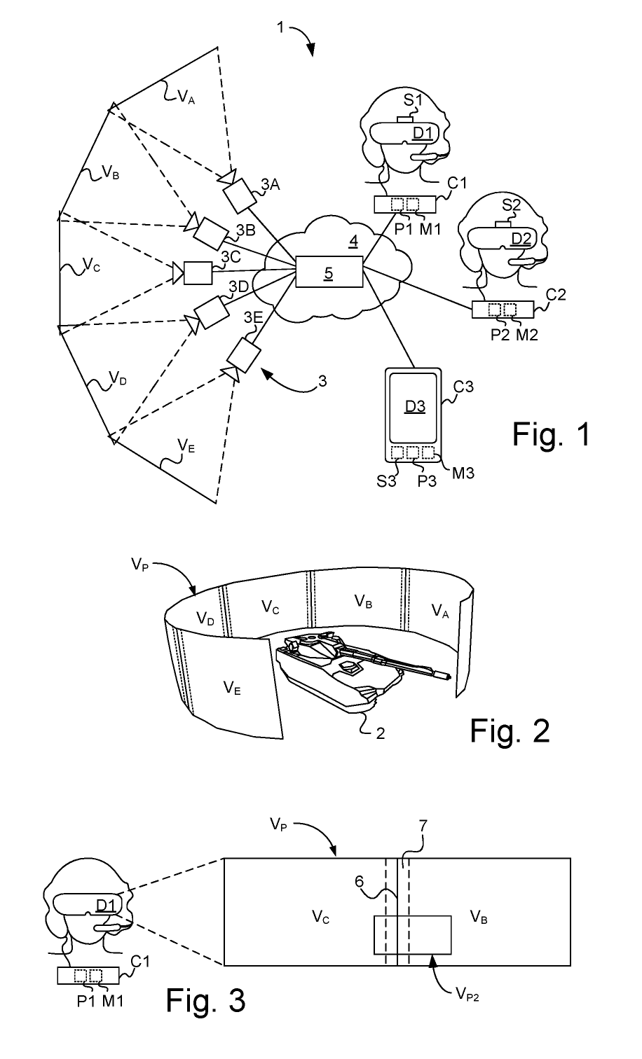

With simultaneous reference to FIGS. 1-3, a system 1 for providing situation awareness in a combat vehicle 2 will be described.

The situation awareness system 1 is configured to be integrated in the combat vehicle 2. Herein, the combat vehicle 2 is described as a land vehicle, such as a tank, but it should be noted that the system can also be realised and implemented in a watercraft, such as a surface vessel, or an airborne vehicle, such as e.g. a helicopter or an airplane.

The system 1 comprises a sensor device 3 comprising a plurality of image-capturing sensors 3A-3E, each arranged to record an image sequence showing at least a part of the surroundings of the combat vehicle during operation.

The image-capturing sensors 3A-3E may be digital electro-optical sensors, comprising at least one electro-optical sensor for capturing image sequences constituting still image sequences and/or video sequences.

The image-capturing sensors 3A-3E may be digital cameras or video cameras configured to record images within the visual and/or infrared (IR) range. They may also be constituted by image amplifiers configured to record images in the near infrared (NIR) range.

The image-capturing sensors 3A-3E may be arranged on the exterior of the combat vehicle 2 or in the interior of the combat vehicle 2 protected by transparent, protective material through which recording of image sequences is performed.

The image-capturing sensors 3A-3E are preferably aligned relative to each other so that the image-capturing areas of the different sensors, i.e. the partial views referred to as V_{A}-V_{E} in FIG. 1, partially overlap. Although the exemplary embodiment of FIG. 1 only comprises five image-capturing sensors 3A-3E arranged to cover a field of view of nearly 180-degrees, it should be understood that the system 1 advantageously may comprise an arbitrary number of image-capturing sensors, which advantageously are arranged to cover 360° of the surroundings of the combat vehicle.

Further, the system 1 comprises a plurality of client devices C1-C3, each associated with a screen or display D1-D3, which may be integrated in or connected to the client device. The client devices are configured to receive image sequences from the image-capturing sensors 3A-3E, preferably one or two image sequences at a time, and to process and, if necessary, merge images from the different image sequences for display on the display D1-D3 associated with the client device, as will be described in more detail below.

For this purpose, the client devices C1-C3 comprise a data processing device or processor P1-P3 and a digital storage medium or memory M1-M3. It should be realized that the actions or method steps referred to herein as being performed by a client device C1-C3 are performed by the processor P1-P3 of the client device through execution of a certain part, i.e. a certain program code sequence, of a computer program stored in the memory M1-M3 of the client device.

In one embodiment, the client devices are constituted by standard computers in the sense that they do not comprise any special-purpose hardware for processing the received image sequences. The client devices may for example be constituted by laptop or desktop personal computers or smaller portable computing devices, such as a tablet computer or a tablet device. In FIG. 1, the client devices C1 and C2 are constituted by personal computers connected to external displays D1, D2 in the form of helmet displays integrated in helmets worn by crew members of the combat vehicle 2, while the client device C3 is constituted by a tablet computer intended to be held by hand by an additional crew member of the combat vehicle 2. It should thus be understood that the client devices C1-C3 are separate and independent data processing devices.

The client devices C1-C3 and the image-capturing sensors 3A-3E are all connected to a network 4 of the combat vehicle 2. In a preferred embodiment, the network is an Ethernet network, preferably a Gigabit Ethernet network (GigE). The client devices C1-C3 are connected to the image-capturing sensors 3A-3E over said network 4 via a network switch 5, typically in the form of an Ethernet switch.

The image-capturing sensors 3A-3E are configured to record image sequences showing a respective partial view V_{A}-V_{E} of the surroundings of the combat vehicle, and to send these image sequences over said network 4 by means of a technique (e.g. multicast technique) which enables a plurality of receivers to be reached by a certain image sequence even if said image sequence is sent only once by an image-capturing sensor 3A-3E. Each client device C1-C3 is in turn configured to receive, via said network 4, one or more image sequences showing different partial views V_{A}-V_{E} of the surroundings of the combat vehicle and to generate, on its own, a desired view by processing the images from the received image sequence(s), and to provide for display of the desired view on said display D1-D3.

In the exemplary embodiment shown in FIGS. 1-3, the situation awareness system 1 is used for displaying, on the displays D1-D3 associated with the client devices C1-C3 of the vehicle crew, streamed video of the surroundings of the combat vehicle, created by processing one or more video streams recorded by the image-capturing sensors 3A-3E. In this embodiment, the client devices C1-C3 are capable of showing panoramic video created by merging of two or more video streams recorded by the image-capturing sensors 3A-3E.

In this embodiment, the image-capturing sensors 3A-3E are constituted by digital network video cameras configured to record the image sequences which thus constitute the video streams depicting the different partial views V_{A}-V_{E} of the surroundings of the combat vehicle. More specifically, in this embodiment, the image-capturing sensors 3A-3E are constituted by Ethernet video cameras with multicast functionality, which means that the video cameras 3A-3E are connected to the Ethernet network 4 and are configured to send each recorded image sequence by means of a technique that although each image sequence is sent only once can be received by a plurality of receivers, i.e. client devices.

Furthermore, the client devices C1-C3 of this embodiment comprise a respective direction sensor S1-S3 configured to sense a current direction of the direction sensor and thus the direction of the client device or the component of which the direction sensor forms a part. This enables a user of a client device C1-C3 to indicate a desired view of the surroundings of the combat vehicle by directing the client device or a component attached thereto, comprising the direction sensor S1-S3, in the direction the user desires to “see”. As illustrated in FIG. 1, the direction sensor S1-S2 can, for example, be attached to a helmet or helmet mounted display D1-D2 and be connected to the client device C1-C2 to allow the user to indicate desired view of the surroundings of the combat vehicle by turning the head and “look” in the desired direction. As also illustrated in FIG. 1, the direction sensor S3 can in other cases be integrated in a portable client device, such as the tablet computer C3, wherein the user can indicate desired view by directing the tablet computer in the direction he wishes to see. In a further embodiment (not shown), the situation awareness system 1 may comprise means for eye tracking, such as a camera arranged to detect eye movements of a user of a client device C1-C3, wherein the user may be allowed to indicate the desired view of the surroundings of the combat vehicle by looking in a particular direction.

From the above description it should be understood that the observation system 1 typically comprises an MMI (man-machine interface) configured to allow the user to indicate a desired view by indicating, via said MMI, a direction in which the user wants to see the surroundings of the combat vehicle, and that such an MMI can be designed in several different ways. Thus, it should be understood that the observation system 1 of the present disclosure is not restricted to any of a number of possible solutions for providing such functionality.

When a user of a client device C1-C3 indicates a desired view of the surroundings of the combat vehicle, the client device calculates which one(s) of the partial views V_{A}-V_{E} that is/are required to generate the desired view.

In the event that the desired view can fit within one of the partial views V_{A}-V_{E}, that is, if the image information desired by the operator to be displayed on the display D1-D3 corresponds to or is a subset of one of the partial views V_{A}-V_{E}, the client device C1-C3 only needs to demand and receive image sequences from a single image-capturing sensor 3A-3E and not carry out any merging of images. Even in this situation, however, a certain degree of processing of the images comprised in the image sequence is required in order to generate, from those images, the desired view for display on the display D1-D3. For example, the processing may in this case consist of extracting parts of the images, projecting the images or the extracted image parts on a curved surface and/or rescaling the images or the extracted image parts before they are presented as said desired view on the display D1-D3 associated with the client device C1-C3.

Thus, the desired view can be generated from an image sequence recorded by a single image-capturing sensor 3A-3E. Advantageously, the client devices C1-C3 are configured to, based on an indication of desired view of the surroundings of the combat vehicle, indicated by the user of the respective client device by means of, for example, the above mentioned direction sensors S1-S3, determine from how many and which of the image-capturing sensors 3A-3E the image sequences have to be obtained in order to generate the desired view. Furthermore, the client devices C1-C3 are advantageously configured to request, from the image-capturing sensors, the image sequences and only the image sequences required to generate the desired view. This means that the client devices C1-C3 to the extent possible strive to generate the desired view from an image sequence recorded by a single image-capturing sensor 3A-3E and that further image sequences from other image-capturing sensors 3A-3E are only requested if necessary. Nevertheless, for descriptive purposes, it will henceforth be assumed that the view desired by the user requires merging of images from at least two image sequences recorded by different image-capturing sensors 3A-3E, in order to create a panoramic image corresponding to said desired view to be displayed to the user.

As illustrated in FIG. 2, the client device may in some embodiments be configured to create a complete, up to 360-degree panoramic view by merging all or at least a larger number of image sequences depicting different partial views V_{A}-V_{E}, and to provide for display of the whole or parts of this up to 360-degree panoramic view on the display of the client device.

As mentioned above, the client devices C1-C3 are, however, configured to minimize the number of image sequences used to generate the view desired by the user and, as this does usually not require merging of more than two or a maximum of three image sequences, the client devices C1-C3 are advantageously configured to limit the requests for image sequences from the different video cameras to two or maximum three image sequences.

FIG. 3 shows an example of this where the client device C1 has requested two image sequences recorded by different video cameras and depicting two partially overlapping partial views V_{B}, V_{C} of the surroundings of the combat vehicle. The client device C1 is further configured to merge the two partial views to a panoramic view by stitching the two partial views with one seam 6, typically by using image information comprised in the overlapping areas 7 of the two partial views V_{B}, V_{C} according to principles well known in the art of image processing.

In the example shown in FIG. 3, the client device C1 has thus sent a request to the switch 5 (see FIG. 1) to obtain video streams from the video cameras 3B and 3C based on an indication from the user of the client device of a desired view to be displayed on the display D1 of the client device. In response to this request, the switch 5 has sent the video streams from the video cameras 3B and 3C to the client device C1, whereupon the client device by means of software for generating panoramic images, stored in the memory M1 of the client device, has merged the images depicting the partial views V_{B}, V_{C} to a panoramic view which, in this example, comprises the desired view V_{P} that is showed on the display D1. Although the seam 6 between the merged partial views for explanatory reasons is shown in FIG. 3, it is to be understood that the panoramic view showed on the display D1 is normally completely seamless in the sense that the seam or seams between merged images from a plurality of image sequences is/are usually not visible in the merged panoramic image.

It should also be appreciated that the desired view V_{P} displayed on the display D1 does not have to comprise the whole partial views V_{B}, V_{C}, or even an entire partial view. Instead, the desired view displayed on the display D1 typically constitutes a subset of a merged image that the client device C1 generates from the requested and received video streams. For example, the client device C1 can demand video streams from the video cameras 3B and 3C, whereupon the client device can receive these video streams and thus the partial views V_{B}, V_{C}, generate a merged image corresponding to the view V_{P} in FIG. 3 by stitching the partial views V_{B} and V_{C} and store this merged image in the memory M1, whereupon a desired view V_{P2} comprising image information from both the partial views V_{B}, V_{C} but only a subset of the image information in said merged image can be displayed on the display D1.

To store an image in the memory M1 of the client device, which image is larger than the image currently being displayed on the display D1 associated with the client device, is advantageous in that it allows for quick updates of the display of the desired view caused by small changes in the indication of desired view from the operators, for example caused by small head movements of an operator provided with an integrated helmet direction sensor S1, S2 by means of which the operator indicates the desired view for display on a display, as described above. The fact that the merged and stored image is larger than the image being displayed as desired view on the display means that there is a certain margin of image information outside the desired and showed view, wherein image information within this margin can be shown when indicated as being desired by the operator, without the need for new calculation-intensive merges of images. For example, the merged image stored in the memory of the client device may correspond to a horizontal field of view of 90 degrees around the vehicle 2 while the desired view being displayed on the display only corresponds to a horizontal field of view of 60 degrees.

As indicated above, the system 1 is advantageously designed such that each client device C1-C3 is configured to request, based on the desired view as indicated by the user of the client device, the minimal number of image sequences from the video cameras 3A-3E required to generate said desired view. In one embodiment, two is the upper limit for the number of image sequences from different video cameras that may be required and merged by the respective client device. In another embodiment, said upper limit is three. In yet another embodiment, the client devices are configured to allow the users, through user input, to specify an upper limit for the number of image sequences that should be requested and merged based on the indication of desired view by the user. In this way, the maximum number of images that are merged by the client device can, for example, be adapted to personal preferences of the respective user and/or to the calculation capacity of each client device.

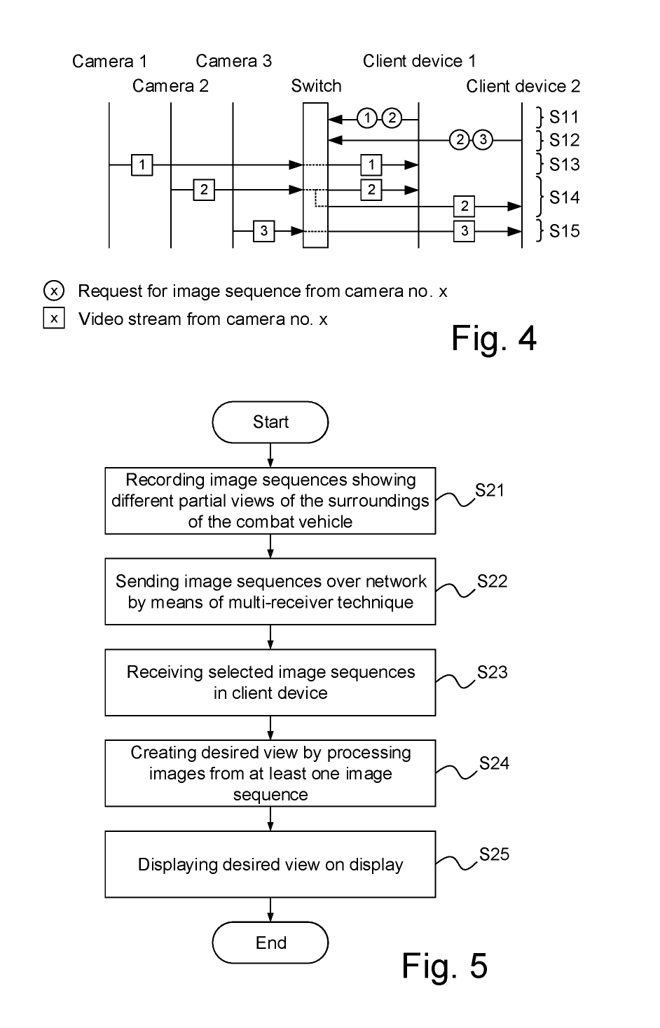

FIG. 4 shows an example of data communication between the devices in the network 4. Thus, the switch of FIG. 4 corresponds to the network switch 5 in FIG. 1, while the video cameras 1-3 and the client devices 1 and 2 in FIG. 4 may be constituted by any of the image-capturing sensors 3A-3E or the client devices C1-C3 of FIG. 1.

In a first step S11, a first client device “Client device 1” sends a request to the switch for image sequences to be sent from the video cameras 1 and 2. As described above, the client device base the choice of video cameras on an indication of desired view for display on a display, received from the user of the client device.

In a second step S12, a second client device “Client device 2” sends, in the same way, a request to the switch for image sequences to be sent from the video cameras 2 and 3.

In a third step S13, the switch receives an image sequence from “Video camera 1” and forwards it to the “Client device 1” since this is the only client device that has requested the image sequence.

In a fourth step S14, the switch receives an image sequence from “Video camera 2”. This is requested by both “Client device 1” and “Client device 2”. Thus, the switch duplicates the image sequence and then sends a respective copy of the image sequence to the two client devices.

In a fifth step S15, the switch receives an image sequence from “Camera 3” and forwards it to “Client device 2” since this is the only client device that has requested the image sequence.

As mentioned above, the network connected video cameras 3A-3E are configured to send the recorded image sequences over the network 4 by means of a technique that allows a plurality of client devices C1-C3 to receive the same image sequence, although this is only sent once by a video camera. In one embodiment, this is accomplished by configuring the network devices, comprised in the Ethernet network 4, for use of IP multicast.

IP multicast is a well-known technology that is frequently used to stream media over the Internet or other networks. The technology is based on the use of group addresses for IP multicast and each video camera 3A-3E is advantageously configured to use a specific group address as the destination address of the data packet that the recorded image sequences are sent in. The client devices then use these group addresses to inform the network that they are interested in some selected image sequences by specifying that they want to receive data packets sent to a specific group address. When a client device informs the network that it wants to receive packets to a specific group address it is said that the client device joins a group with this group address. In one embodiment, the above mentioned requests sent from the client devices C1-C3 to the network switch 6 are such join requests that indicate which video streams the client device wish to receive and thus which it do not wish to receive.

FIG. 5 is a flowchart illustrating an exemplary embodiment of a method for providing situation awareness in a combat vehicle. The method will be described below with simultaneous reference to the previously described figures.

In a first step, S21, a plurality of image sequences are recorded showing partial views V_{A}-V_{E} of the surroundings of the combat vehicle by means of a plurality of image-capturing sensors 3A-3E.

In a second step, S22, these image sequences are sent over a network 4 comprised in the combat vehicle 2 by means of multi-receiver technique i.e. a technique in which each image sequence can be received by a plurality of receivers, such as multicast.

In a third step, S23, selected image sequences are received in the client devices C1-C3. As mentioned earlier, the client devices C1-C3 are preferably configured to request and receive image sequences from a minimum of image-capturing sensors 3A-3E, where the image-capturing sensors and thus the requested image sequences are selected by the client device based on an indication of desired view for display, received by the client device from a user thereof.

In a fourth step S24, each client device creates, on its own, the desired view by processing images from at least one received image sequence and, if more than one image sequence is needed to create the desired view, by merging images from at least two image sequences recorded by different image-capturing sensors. As mentioned above, the desired view is typically but not necessarily a part of a panoramic view created in and by the respective client device by software for generating panoramic images from a plurality of image sequences, which software is stored in the respective client device.

In a fifth step, S25, each client device displays the desired view on a display D1-D3 associated with the respective client device.

It has been described that the desired view showed on the client device display can be a merged image composed by images from different image sequences. These images may advantageously be constituted by video stream frames. Thus, it should be understood that in a preferred embodiment, a panoramic video, or part of a panoramic video, is displayed on the displays of the client devices, generated by merging of frames from video streams recorded by the video cameras 3A-3E.

The foregoing description of preferred embodiments of the invention has been provided in illustrative and descriptive purpose. It is not intended to be exhaustive or to limit the invention to the precise embodiments described. Therefore, it should be understood that the invention intends to comprise all possible embodiments that fall within the scope of the following claims.

1. A system for situation awareness in a combat vehicle, the system comprising:
a plurality of image-capturing sensors, each configured to record an image sequence showing a partial view of surroundings of the combat vehicle, and
a plurality of client devices, each configured to show a view of the surroundings of the combat vehicle, desired by a user of the client device, on a display,
wherein the image-capturing sensors are configured to be connected to a network and to send said image sequences over said network by a technique in which each image sequence sent by an image-capturing sensor can be received by a plurality of receivers, and
each of said client devices is configured to be connected to said network and to receive, via said network, at least one image sequence recorded by at least one image-capturing sensor, and to generate, on its own, said desired view from said at least one image sequence by processing images from said at least one image sequence, and to provide for showing of the desired view on said display.

2. The system according to claim 1, wherein at least one of the client devices is configured to receive a plurality of image sequences recorded by different image-capturing sensors, merge images from the received image sequences into a merged image comprising image information recorded by different image-capturing sensors and display, on said display, the merged image or part thereof as said desired view.

3. The system according to claim 2, wherein said merged image is a panoramic image.

4. The system according to claim 1, wherein at least one of the client devices is configured to receive an indication from a user of the client device on said desired view, and to request and receive only the image sequences required to generate said desired view, based on said indication.

5. The system according to claim 4, wherein said at least one client device is configured to request and receive at most three and preferably only one or two image sequences to generate said desired view.

6. The system according to claim 1, further comprising a network switch via which the image-capturing sensors are connected to the client devices, wherein the client devices are configured to send requests to the network switch for selected image sequences to be sent in order to generate said desired view, wherein the network switch is configured to selectively communicate the requested image sequences from the different image-capturing sensors to the different client devices, based on said requests.

7. The system according to claim 6, wherein at least one of the client devices or a component connected thereto comprises a direction sensor, wherein the client device is configured to base said request for selected image sequences to be sent on a current direction of the client device or the component connected thereto.

8. The system according to claim 1, wherein said network is an Ethernet network.

9. The system according to claim 1, wherein the image-capturing sensors are video cameras.

10. The system according to claim 1, wherein said system does not comprise any image processing hardware which modifies the image sequences from the time when they are sent by the image-capturing sensors until they are received by the client devices.

11. The system according to claim 1, wherein said client devices are constituted by general-purpose computers without special-purpose video processing cards, special-purpose plug-in cards, or other special-purpose hardware for processing the image sequences, usually not found in general-purpose computers.

12. A combat vehicle characterized in that it comprises a system according to claim 1 for providing situation awareness for vehicle operators inside the combat vehicle.

13. A method for situation awareness in a combat vehicle, comprising the steps of:
recording a plurality of image sequences showing partial views of surroundings of the combat vehicle by a plurality of image-capturing sensors,
displaying, on each of a plurality of displays associated with a respective client device of a plurality of client devices, a view of the surroundings of the combat vehicle, desired by a user of the client device, and
sending the image sequences from the image-capturing sensors over a network of the combat vehicle by a technique in which each image sequence can be received by a plurality of receivers,
wherein in each of said plurality of client devices the method further comprises the steps of:
receiving, over said network, at least one image sequence recorded by at least one image-capturing sensor;
generating, from said at least one image sequence, said desired view by processing images in said at least one image sequence, and
displaying the desired view on the display associated with the client device.

14. The method according to claim 13, comprising the steps of receiving, in at least one of said plurality of client devices, a plurality of image sequences recorded by different image-capturing sensors, processing the images by merging images from the different image sequences to a merged image comprising image information recorded by different image-capturing sensors, and displaying, on said display, the merged image or part thereof as said desired view.

15. The method according to claim 14, wherein merging is performed such that the merged image constitutes a panoramic image.

16. The method according to claim 13, further comprising the steps of receiving, in at least one of said plurality of client devices, an indication from a user of the client device on said desired view, and, by the client device, requesting and receiving only the image sequences required to generate said desired view, based on said indication.

17. The method according to claim 16, wherein the step of requesting and receiving only the image sequences required to generate said desired view by the client device involves requesting and receiving at most three and preferably only one or two image sequences in order to generate said desired view.

18. The method according to claim 13, further comprising the steps of:
connecting the image-capturing sensors and the client devices to each other via a network switch of the network;
sending, from the respective client device, requests to the network switch for selected image sequences to be sent in order to generate said desired view;
by the network switch, selectively communicating the requested image sequences from the image-capturing sensors to the client devices, based on said requests.

19. The method according to claim 18, further comprising the steps of:
registering a direction of the respective client device or a component connected to the respective client device, and
sending, from the respective client device, said request for selected image sequences to be sent in order to generate said desired view based on said direction.

20. A computer program stored in non-transitory storing medium for providing situation awareness in a combat vehicle comprising a plurality of image-capturing sensors configured to record image sequences showing respective partial views of surroundings of the combat vehicle, the computer program comprising:
program code which when executed by a processor in a client device causes the client device to show a view of the surroundings of the combat vehicle, desired by a user of the client device, on a display, and
program code which when executed by said processor causes the client device to, via a network of the combat vehicle over which the image-capturing sensors send said image sequences by a technique in which each image sequence can be received by a plurality of receivers:
receive at least one image sequence recorded by at least one image-capturing sensor;
generate, based on said at least one image sequence, said desired view by processing images from said at least one image sequence, and
display the desired view on said display.

21. A computer program product comprising the computer program according to claim 20, wherein the non-transitory storing medium comprises non-volatile memory.
